(19) United States
(12) Patent Application Publication
(10) Pub. No.: US 2026/0257755 A1
(43) Pub. Date: Sep. 3, 2026

(54) BICYCLE BRAKE CALIPER DEVICE

(71) Applicant: AD-II Engineering Inc., Taichung City (TW)

(72) Inventors: KUEI-JUNG CHANG, Taichung City (TW); CHUNG-REN CHANG, Taichung City (TW)

(21) Appl. No.: 19/066,543

(22) Filed: Feb. 28, 2025

(51) Int. Cl. B62L 1/00

(52) U.S. Cl. CPC B62L 1/005

(57) ABSTRACT

A bicycle brake caliper device is provided, wherein the bicycle brake caliper device includes: a caliper including a caliper body and a piston, the piston defining a central axis extending in an axial direction, the piston being disposed in the caliper body and being movably relative to the caliper body in the axial direction, the caliper body including an assembling side including a first assembling portion, the first assembling portion including a plurality of first assembling structures, each of the plurality of first assembling structures having a centerline parallel to the central axis; and an adapter configured to be connected to a bicycle frame and including a second assembling portion, the second assembling portion being detachably assembled to the first assembling portion in the axial direction by one of a plurality of attachment members in the centerline of one of the plurality first assembling structures.

### BACKGROUND OF THE INVENTION

### Field of the Invention

The present invention relates to a bicycle brake caliper device, particularly to a technical improvement of a bicycle brake caliper device including an adapter.

### Description of the Prior Art

Typically, a brake caliper assembly of a vehicle (such as a bicycle or a motorcycle) is assembled on a frame (such as a front fork or a rear fork). In conventional technology, a brake caliper is assembled on a fixing frame by connecting members, and the fixing frame is connected to the frame to accommodate the need to adjust the distance between the front and rear wheels (e.g., when replacing a transmission chain of a different size), thereby changing the position of the brake disc.

However, when the fixing frame of the conventional technology is installed on the frame, the connecting members are hidden between the frame and the fixing frame. As a result, the fixing frame must be removed from the frame before the brake caliper can be detached from the fixing frame, leading to inconvenience in disassembly, assembly, adjustment, and maintenance..

The present invention is, therefore, arisen to obviate or at least mitigate the above-mentioned disadvantages.

### SUMMARY OF THE INVENTION

The main object of the present invention is to provide a bicycle brake caliper device which allows the caliper to be directly disassembled and assembled while the adapter remains installed on the bicycle frame.

To achieve the above and other objects, a bicycle brake caliper device is provided, wherein the bicycle brake caliper device includes: a caliper including a caliper body and a piston, the piston defining a central axis, the central axis extending in an axial direction, the piston being disposed in the caliper body and being movably relative to the caliper body in the axial direction, the caliper body including an assembling side, the assembling side including a first assembling portion, the first assembling portion including a plurality of first assembling structures, each of the plurality of first assembling structures having a centerline parallel to the central axis; and an adapter configured to be connected to a bicycle frame and including a second assembling portion, the second assembling portion being detachably assembled to the first assembling portion in the axial direction by one of a plurality of attachment members in the centerline of one of the plurality first assembling structures.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a first exemplary embodiment of the present invention;

FIG. 2 is an exploded view of the first exemplary embodiment of the present invention;

FIG. 3 is a bottom view of the first exemplary embodiment of the present invention;

FIG. 4 is a cross-sectional view of the first exemplary embodiment of the present invention;

FIG. 5 is a perspective view of a second exemplary embodiment of the present invention;

FIG. 6 is an exploded view of the second exemplary embodiment of the present invention;

FIG. 7 is another exploded view of the second exemplary embodiment of the present invention; and

FIG. 8 is a drawing showing operation of the second exemplary embodiment of the present invention.

### DETAILED DESCRIPTION OF THE PREFERRED EMBODIMENTS

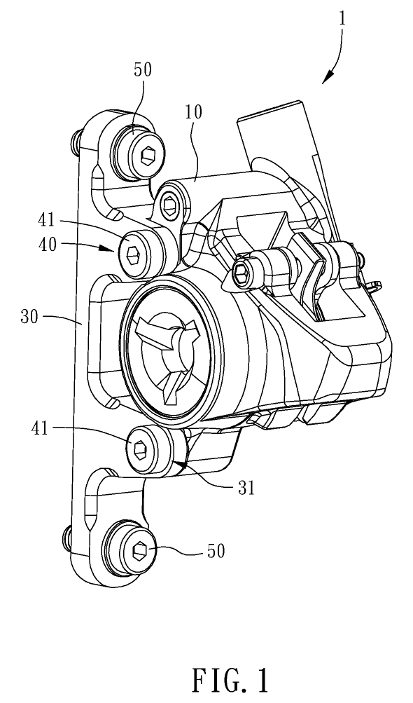

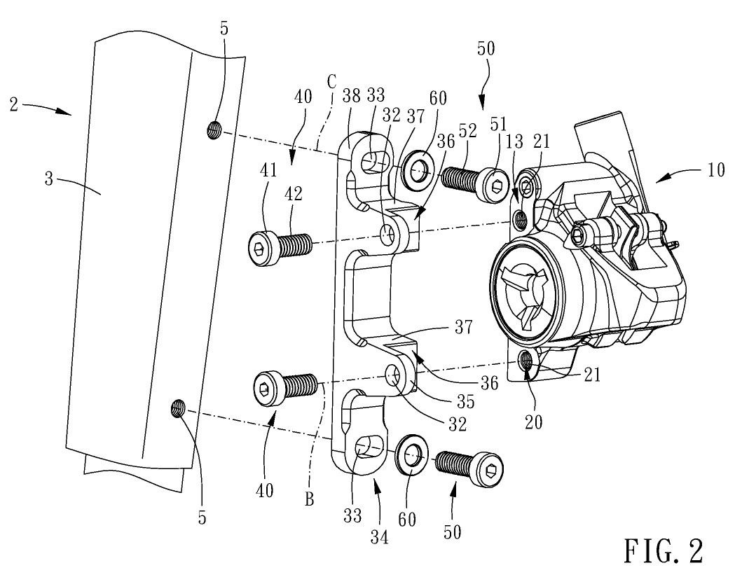

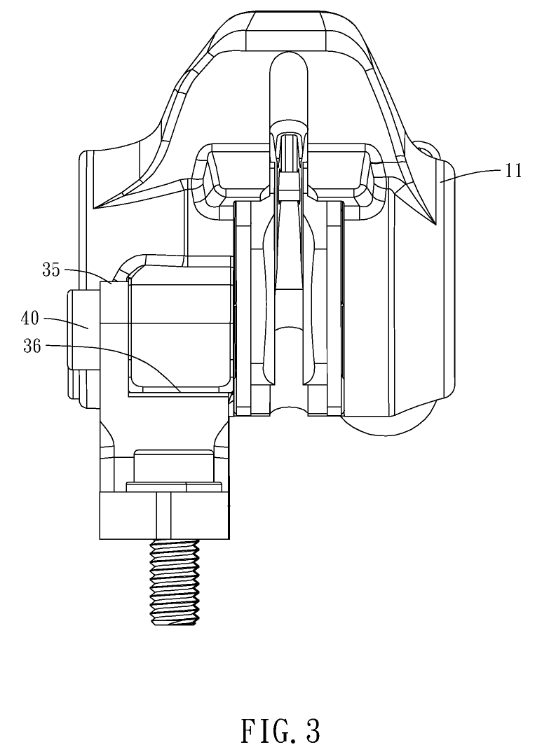

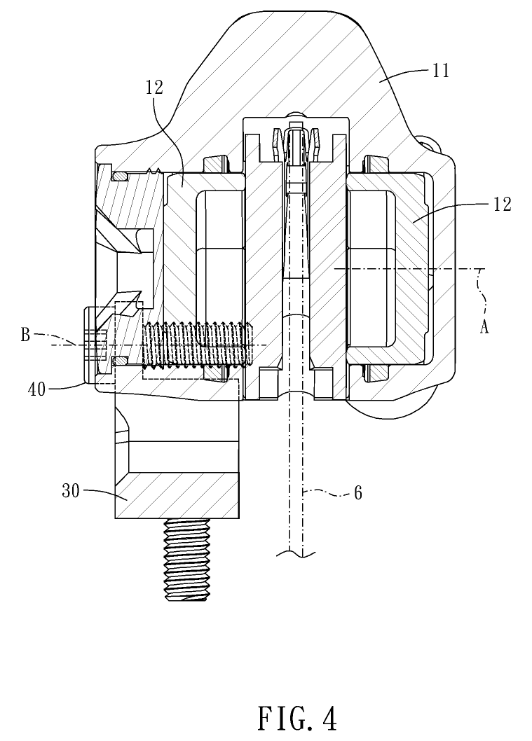

Please refer to FIGS. 1 to 4 for an exemplary embodiment of the present invention. A bicycle brake caliper device 1 of the present invention includes a caliper 10 and an adapter 30.

The caliper 10 includes a caliper body 11 and a piston 12. The piston 12 defines a central axis A, and the central axis A extends in an axial direction. The piston 12 is disposed in the caliper body 11 and is movably relative to the caliper body 11 in the axial direction. In this embodiment, the caliper 10 includes a plurality of pistons 12 disposed on opposite sides, and each of the plurality of pistons piston 12 is configured to be actuated to move in the axial direction toward a disc 6 to apply braking force to the disc 6. The caliper body 11 includes an assembling side 13, and the assembling side 13 includes a first assembling portion 20. The first assembling portion 20 includes a plurality of first assembling structures 21, and each of the plurality of first assembling structures 21 has a centerline B parallel to the central axis A. The adapter 30 is configured to be installed on a bicycle frame 2 (e.g., selectively installed on a front fork 3 or a rear fork 4). The adapter 30 includes a second assembling portion 31, and the second assembling portion 31 is detachably assembled to the first assembling portion 20 in the axial direction by one of a plurality of attachment members 40 along the centerline B of one of the plurality of first assembling structures 21.

As such, since the caliper 10 is assembled laterally to the adapter 30, the caliper 10 can be conveniently disassembled and assembled. Specifically, when the adapter 30 is assembled to the bicycle frame 2, the attachment member 40 is not obstructed by the bicycle frame 2 but is exposed outside the bicycle frame 2. In this way, the caliper 10 can be directly disassembled and assembled without detaching the adapter 30 from the bicycle frame 2. Furthermore, the relative position of the caliper 10 and the disc 6 in the axial direction can be adjusted.

The second assembling portion 31 includes a plurality of second assembling structures 32, and the plurality of second assembling structures 32 correspond to the plurality of first assembling structures 21. The plurality of attachment members 40 extend through the plurality of first assembling structures 21 and the plurality of second assembling structures 32. The plurality of first assembling structures 21 are separately arranged at intervals, and the plurality of second assembling structures 32 are also separately arranged at intervals. Specifically, each of the plurality of first assembling structures 21 is a threaded hole, each of the plurality of attachment members 40 is a threaded fastener, and each of the plurality of attachment members 40 is detachably screwed to one of the plurality of first assembling structures 21. Preferably, each of the plurality of attachment members 40 includes a head portion 41 and a body portion 42 connected to each other. Each of the plurality of second assembling structures 32 is a through hole. The body portion 42 extends through one of the first assembling structures 21 and one of the plurality of second assembling structures 32. An outer diameter dimension of the head portion 41 is greater than an inner diameter dimension of the second assembling structure 32. Therefore, each of the plurality of attachment members 40 is locked in one of the plurality of second assembling structures 32, and the head portion 41 is configured to abut the adapter 30 in a direction toward the caliper 10. As such, the adapter 30 supports the caliper 10 in the axial direction. Furthermore, each of the plurality of attachment members 40 can be operated to finely adjust the relative position of the caliper 10 and the disc 6 in the axial direction. Additionally, the head portion 41 includes a tool engagement hole configured for engagement with a disassembly tool, and the head portion 41 is located outside the second assembling structure 32, allowing the head portion 41 to be loosened or tightened by a tool or by hand.

The adapter 30 further includes a base 34. The caliper 10 abuts the base 34. The second assembling portion 31 includes a plurality of projections 35 separately arranged, and a plurality of second assembling structures 32. The plurality of projections 35 project transversely from the base 34, and each of the plurality of projections 35 includes one of the plurality of second assembling structures 32. The plurality of attachment members 40 extend through the plurality of first assembling structures 21 and the plurality of second assembling structures 32. In this embodiment, the plurality of projections 35 are separately arranged at intervals, which can disperse the abutting force of the caliper 10. In this embodiment, the number of the plurality of projections 35 is two, but it is not limited thereto. Preferably, the caliper body 11 abuts the plurality of projections 35. Specifically, the caliper 10 is supported transversely to the axial direction on the base 34 and abuts the plurality of projections 35 in parallel to the axial direction. Therefore, the adapter 30 can support the caliper 10 in two directions, enabling the caliper 10 to be stably supported. Preferably, the base 34 includes at least one thick section 37 and at least one thin section 38, and a height difference is formed between each of the thin sections 38 and each of the thick sections 37. The two projections 35 are disposed on the thick section 37. Specifically, the base 34 further includes a bearing end face 36, the caliper 10 abuts the bearing end face 36 in a first direction, and the plurality of projections 35 are disposed on one side of the base 34 and extend from the base 34 in the first direction. The first direction is transverse to the axial direction. Preferably, each of the thick sections 37 forms the bearing end face 36. In this embodiment, the base 34 includes a plurality of thick sections 37 that are separately arranged at intervals. The thick sections 37 have high structural strength, which can stably support the caliper 10 and reduce the contact area between the caliper 10 and the base 34, thereby preventing wear. In other embodiments, the base may include one of the thick sections and a plurality of the thin sections, but it is not limited thereto.

The adapter 30 further includes two connection holes 33, and the adapter 30 is connected to the bicycle frame 2 by two connecting members 50, which are disposed through the two connection holes 33 and two assembling holes 5 of the bicycle frame 2. Each of the connection holes 33 has a centerline C transverse to the centerline B of each of the plurality of first assembling structures 21. Each of the assembling holes 5 may be a threaded hole or a through hole, and each of the plurality of connecting members 50 may be a threaded fastener. Preferably, the bicycle brake caliper device 1 further includes a plurality of washers 60. Each of the plurality of connecting members 50 includes an enlarged section 51 and a body section 52 connected to each other. Each of the plurality of washers 60 is disposed between the enlarged section 51 of one of the plurality of connecting members 50 and the adapter 30. The body section 52 extends through one of the connection holes 33, and the enlarged section 51 can press against one of the plurality of washers 60. Specifically, each of the plurality of washers 60 allows fine-tuning of the fastening position or reduces direct wear, ensuring a more precise gap or alignment between the caliper 10 and the disc 6.

In this embodiment, the bicycle brake caliper device 1 is configured to be installed on the front fork 3 of the bicycle frame 2. Each of the plurality of connection holes 33 is a through hole extending through opposite sides of the adapter 30 in the first direction and being disposed on opposite sides of the plurality of first assembling structures 21 in the extending direction of the base 34. Each of the plurality of connecting members 50 can be disposed through one of the plurality of connection holes 33 and be fastened to the two assembling holes 5 of the bicycle frame 2, wherein each of the plurality of assembling holes 5 is a threaded hole.

In use, the adapter 30 is installed, the relative position between the adapter 30 and the disc 6 is adjusted, and finally, the caliper 10 is installed on the adapter 30. Therefore, when removing the caliper 10 for reinstallation, it only needs to be installed onto the adapter 30 without readjusting the position of the adapter 30, making it convenient to use.

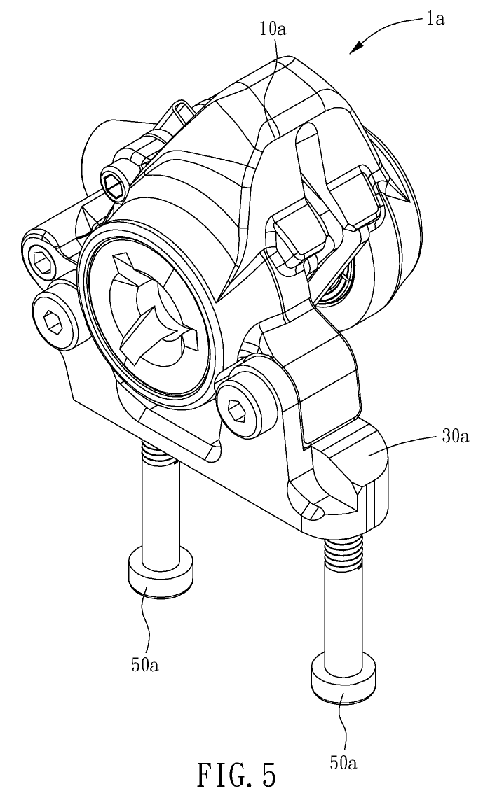

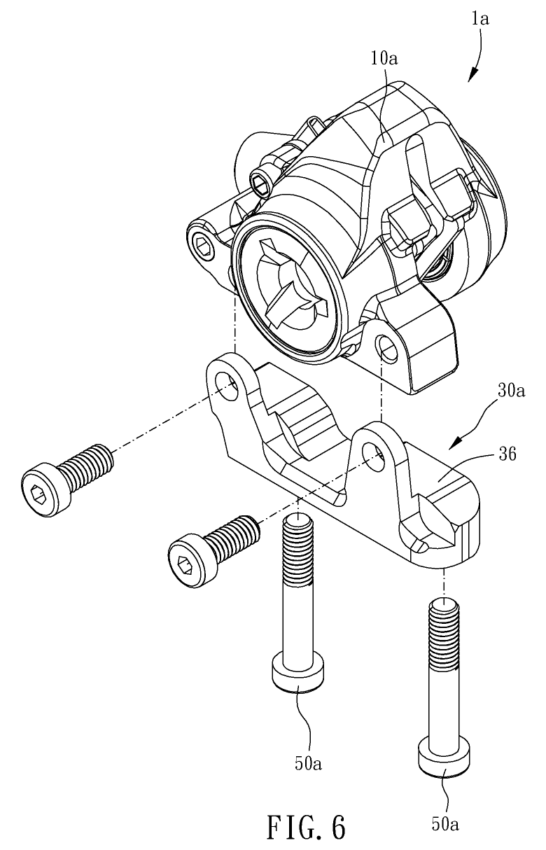

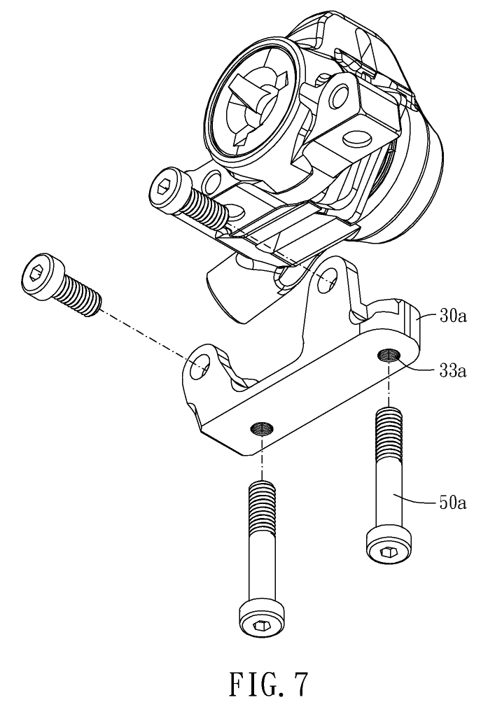

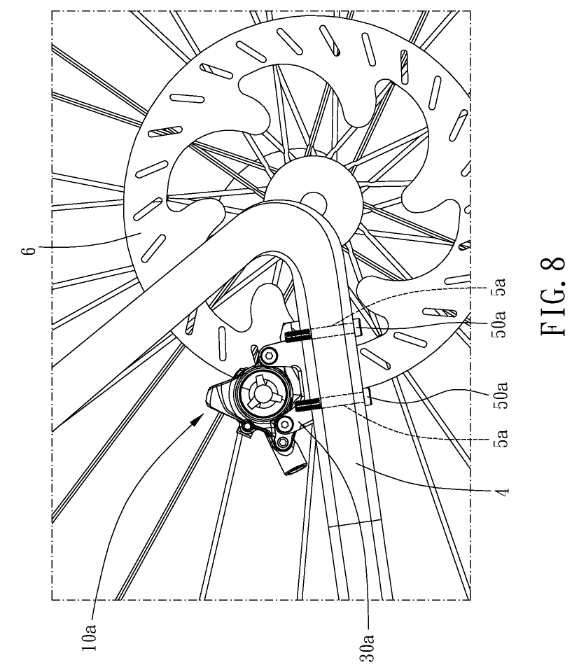

Please refer to FIGS. 5 to 8, which show a second exemplary embodiment of the present invention. The bicycle brake caliper device 1a is configured to be installed on a rear fork 4 of a bicycle frame. The plurality of connection holes 33a are disposed on the base 34 on one side relative to the bearing end face 36, and each of the plurality of connection holes 33a is a threaded hole. Each of the plurality of connecting members 50a is disposed through the two assembling holes 5a of the bicycle frame 2 and be fastened to one of the plurality of connection holes 33a of the caliper 10a, wherein each of the plurality of assembling holes 5a is a through hole. In this embodiment, each of the plurality of connection holes 33a is a threaded hole.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bicycle brake caliper device including:
a caliper including a caliper body and a piston, the piston defining a central axis, the central axis extending in an axial direction, the piston being disposed in the caliper body and being movably relative to the caliper body in the axial direction, the caliper body including an assembling side, the assembling side including a first assembling portion, the first assembling portion including a plurality of first assembling structures, each of the plurality of first assembling structures having a centerline parallel to the central axis; and
an adapter configured to be connected to a bicycle frame and including a second assembling portion, the second assembling portion being detachably assembled to the first assembling portion in the axial direction by one of a plurality of attachment members in the centerline of one of the plurality first assembling structures.

2. The bicycle brake caliper device of claim 1, wherein the second assembling portion includes a plurality of second assembling structures, the plurality of second assembling structures corresponding to the plurality of first assembling structures, and the plurality of attachment members are disposed through the plurality of first assembling structures and the plurality of second assembling structures.

3. The bicycle brake caliper device of claim 2, wherein each of the plurality of first assembling structures is a threaded hole, each of the plurality of attachment members is a threaded fastener, and each of the plurality of attachment members is detachably screwed to one of the plurality first assembling structures.

4. The bicycle brake caliper device of claim 3, wherein each of the plurality of second assembling structures is a through hole.

5. The bicycle brake caliper device of claim 2, wherein the adapter further includes two connection holes, the adapter is connected to the bicycle frame by two connecting members which are disposed through the two connection holes and two assembling holes of the bicycle frame, each of the two connection holes has a centerline transverse to the centerline of each of the plurality of first assembling structures.

6. The bicycle brake caliper device of claim 1, wherein the first assembling portion includes a plurality of first assembling structures, the adapter further includes a base, the caliper abuts the base, the second assembling portion includes a plurality of projections separately arranged, and a plurality of second assembling structures, the plurality of projections project transversely from the base, each of the plurality of projections includes one of the plurality of second assembling structures, and the plurality of attachment members are disposed through the plurality of first assembling structures and the plurality of second assembling structures.

7. The bicycle brake caliper device of claim 6, wherein the base includes a bearing end face, the caliper abuts the bearing end face in a first direction, the plurality of projections are disposed on one side of the base and extend from the base in the first direction, and the first direction is transverse to the axial direction.

8. The bicycle brake caliper device of claim 5, wherein each of the two connection holes is a through hole.

9. The bicycle brake caliper device of claim 5, wherein each of the two connection holes is a threaded hole.

10. The bicycle brake caliper device of claim 7, wherein the plurality of second assembling structures correspond to the plurality of first assembling structures, and the plurality of attachment members extend through the plurality of first assembling structures and the plurality of second assembling structures; each of the plurality of first assembling structures is a threaded hole, each of the plurality of attachment members is a threaded fastener, and each of the plurality of attachment members is detachably screwed to one of the plurality first assembling structures; the adapter further includes two connection holes, the adapter is connected to the bicycle frame by two connecting members which are disposed through the two connection holes and two assembling holes of the bicycle frame, each of the two connection holes has a centerline transverse to the centerline of each of the plurality of first assembling structures; each of the plurality of attachment members includes a head portion and a body portion connected to each other, each of the plurality of second assembling structures is a through hole, the body portion is disposed through one of the plurality first assembling structures and one of the plurality of second assembling structures, and an outer diameter dimension of the head portion is greater than an inner diameter dimension of the second assembling structure; the caliper body abuts the plurality of projections.
